(19) United States
(12) Patent Application Publication
(10) Pub. No.: US 2015/0367942 A1
(43) Pub. Date: Dec. 24, 2015

(54) AIRCRAFT

(71) Applicant: SELL GMBH, Herborn (DE)

(72) Inventors: Trystan PARRY, Cardiff (GB); Jean-Marie DAOUT, Mukilteo, WA (US); Zhao Jin, Everett, WA (US); Martin PIERAMICO, Seattle, WA (US)

(21) Appl. No.: 14/761,070

(22) PCT Filed: Feb. 13, 2014
(86) PCT No.: PCT/EP2014/052858

§ 371 Date: Jul. 15, 2015

Related U.S. Application Data
(60) Provisional application No. 61/764,018, filed on Feb. 13, 2013.

(51) Int. Cl. B64D 11/04; B64D 11/00; B64D 11/06

(52) U.S. Cl. CPC B64D 11/04; B64D 11/06; B64D 11/0007

(57) ABSTRACT

An aircraft has at least one floor having a longitudinal axis extending in a flight direction of the aircraft, a plurality of seats and a galley on the floor, and a plurality of carts or container for food, beverages, or utensils in the galley. A receiving space in the galley for the carts or containers extends parallel to the longitudinal axis and has a horizontal dimension transverse to the longitudinal axis that varies.

### CROSS REFERENCE TO RELATED APPLICATIONS

This application is the US-national stage of PCT application PCT/EP2014/052858 filed 13 Feb. 2014 and claiming the priority of U.S. provisional application 61/764,018 filed 13 Feb. 2014.

### FIELD OF THE INVENTION

The present invention relates to an aircraft comprising at least one floor on which a plurality of seats is arranged, wherein furthermore at least one galley is arranged on the floor, wherein the galley comprises a plurality of carts and/or containers for food and/or beverages and/or other utensils, wherein the floor has a longitudinal axis which is oriented in the flight direction of the aircraft.

### BACKGROUND OF THE INVENTION

Aircraft galleys are well known in the art. The galley comprises a number of carts or containers for stowing food and beverages as well as other utensils. The available space for stowing carts is sometimes not used in a most efficient manner. This is a significant drawback as space in an aircraft is always limited and economical and environmental advantages can be taken when the space is used in an optimized way.

Currently, the different regions in an aircraft are regarded independently from another. Accordingly, so called “mid galleys” are designed as rectangular elements to optimize the space in the galley itself. At the other hand the arrangement of the seats especially in the business section is sometimes offset to provide the passenger with the available space as efficient as possible. At the transition between the different sections a dead space is created which cannot be used efficiently,

### OBJECT OF THE INVENTION

Thus, it is an object of the present invention to further develop an aircraft design with a galley in such a way that the available space for stowing carts and containers is used in an optimized manner. So, the limited space in an aircraft should be used as efficient as possible.

### SUMMARY OF THE INVENTION

The solution of this object by the invention is characterized in that the galley has a receiving space for a plurality of carts and/or containers, wherein the receiving space has an extension in the direction of the longitudinal axis and wherein the extension varies in the direction horizontally and perpendicular to the longitudinal axis.

One possible design of this concept is characterized in that the extension of the receiving space is bigger in a center region of the galley than in the lateral region of the galley. In this case the galley has preferably a T-shaped design seen in a top plan view,

Another design is characterized in that the extension of the receiving space is bigger in a lateral region of the galley than in the center region of the galley. In this case the galley has preferably a U-shaped design seen in a top plan view,

The extension of the receiving space can comprise one or two sections with a smaller constant extension and one or two sections with a bigger constant extension. Here, a preferred solution provides that the extension in the bigger section is 1.5 times of the extension in the smaller section. Alternatively, the extension in the bigger section can be 2.0 times of the extension in the smaller section,

Furthermore, it can be provided that two levels are arranged in the galley for receiving and stowing carts and/or containers in two different heights. In this case elevator means can be provided to lift a cart and/or container to the upper level,

Furthermore, pulling means can be provided to pull a cart and/or container out of the receiving space. The pulling means can also be designed to clamp the cart and/or container in the receiving space. Here, a preferred solution provides that the pulling means are designed for a combined translational and rotational movement to move the cart and/or container by the translational movement of the means and to clamp it by the rotational movement of the means,

A specific solution comes up with a galley having a T-shaped design seen in a top plan view which is arranged adjacent to a galley having a U-shaped design seen in a top plan view,

A first galley and a second galley can be arranged with distance in the direction of the longitudinal axis, wherein a plurality of seats is arranged between the two galleys. In this case it is preferred that the first galley in a forward location has a U-shaped design seen in a top plan view and that the second galley in a rear location has a T-shaped design seen in a top plan view,

Preferably, the galley is arranged in a center area of the floor.

Thus, the invention suggests that the shape of the galley is adapted according to the arrangement of the seat. So, the space on the floor can be used in a more efficient manner. Accordingly, due to the orientation of the galley different designs are possible.

According to the invention it becomes possible that additional carts or containers are stowed in the galley in a center region of the galley (T-shape of the galley in a top plan view) or in the lateral regions of the galley (U-shape of the galley in a top plan view.

Also a L-shaped design of the galley is possible; this design is mostly used when a galley is arranged near the doors. Also here, additional space for carts can be established.

Thus, a transition space between seating monument and galleys can be utilized to extend the galley and increase the capacity for stowing carts (trolley, inserts) and containers.

In the case. of the U-shape the galley is extended parallel to the centerline of the aircraft, the passengers in the center being bordered by a galley on both sides.

In the case of the T-shape the galley is extended parallel to the centerline of the aircraft, the passengers in the left hand area and the right hand area being bordered by the extension of the galley on the centerline of the aircraft.

The side monuments can also be used to store carts (trolleys) and be converted in effect in a small galley.

“Full depth carts” and “half depth carts” can be used. i.e. depending on the seat configuration the extension of the “T” can be full depth (full size carts/trolleys can be fitted) and half depth (half size carts/trolleys can be fitted).

A carts/trolley lift system can further augment the galley capacity by adding a second layer of trolleys in the extension of the “T”.

### BRIEF DESCRIPTION OF THE DRAWING

In the drawings embodiments of the invention are shown:

FIG. 1 shows a top plan view onto a part of a floor of an aircraft with seats and galleys,

FIG. 2 shows a view onto the galley according to a possible embodiment of the invention,

FIG. 3 shows a perspective view onto the galley seen from the position of the passengers,

FIG. 4 shows a perspective view onto the galley according to FIG. 3 seen from behind,

FIG. 5 shows a top plan view onto a part of the floor of the aircraft, wherein an alternative galley concept is realized,

FIG. 6 shows a perspective view onto the galley according to an alternative embodiment of the invention seen from behind,

FIG. 7 shows a perspective view onto the galley according to FIG. 6 seen from the position of the passengers,

FIG. 8a shows a top view onto a galley,

FIG. 8b shows a front view onto the galley according to FIG. 8a,

FIG. 8c shows a side view onto the galley according to FIG. 8a,

FIG. 8d shows a bottom view onto the galley according to FIG. 8a,

FIG. 9 shows a top plan view onto a part of the floor of the aircraft, wherein the galley consists of different element,

FIG. 10 shows a top view onto a galley,

FIG. 11 shows the top view onto the galley with pulling means for pulling out a cart,

FIG. 12 shows a cart pulled out by means of the pulling means,

FIG. 13 shows a part of a galley, wherein pulling means are depicted for pulling out a cart,

FIG. 14 shows a similar depiction as in FIG. 13,

FIG. 15 shows a galley with a T-shaped configuration with a full depth extension for carts,

FIG. 18 shows a corresponding galley with a T-shaped configuration with a half depth extension for carts,

FIG. 17 shows another galley with a T-shaped configuration with a full depth extension for carts,

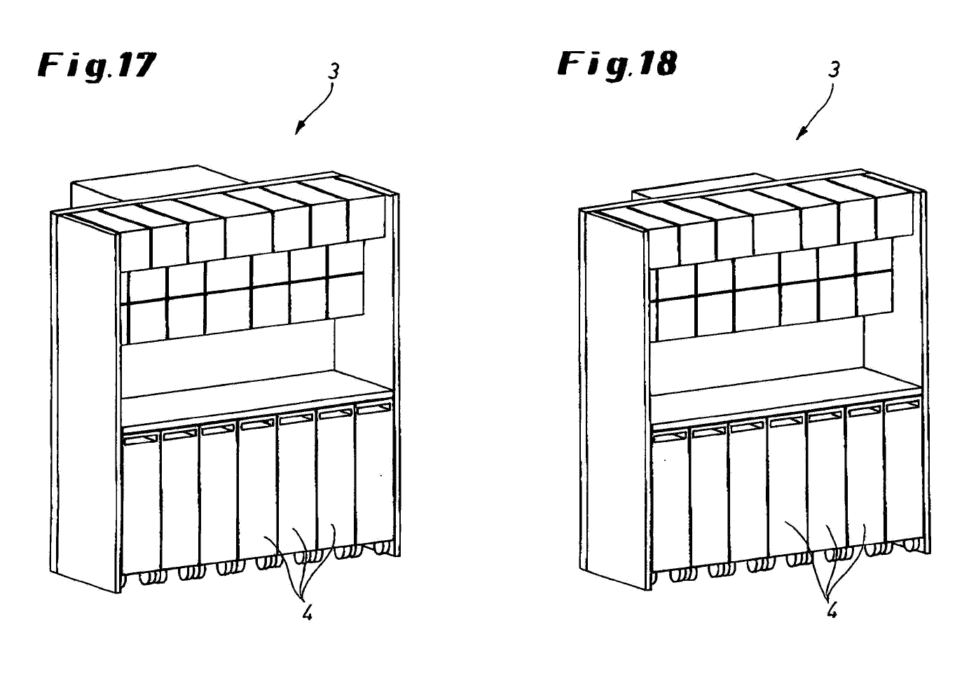

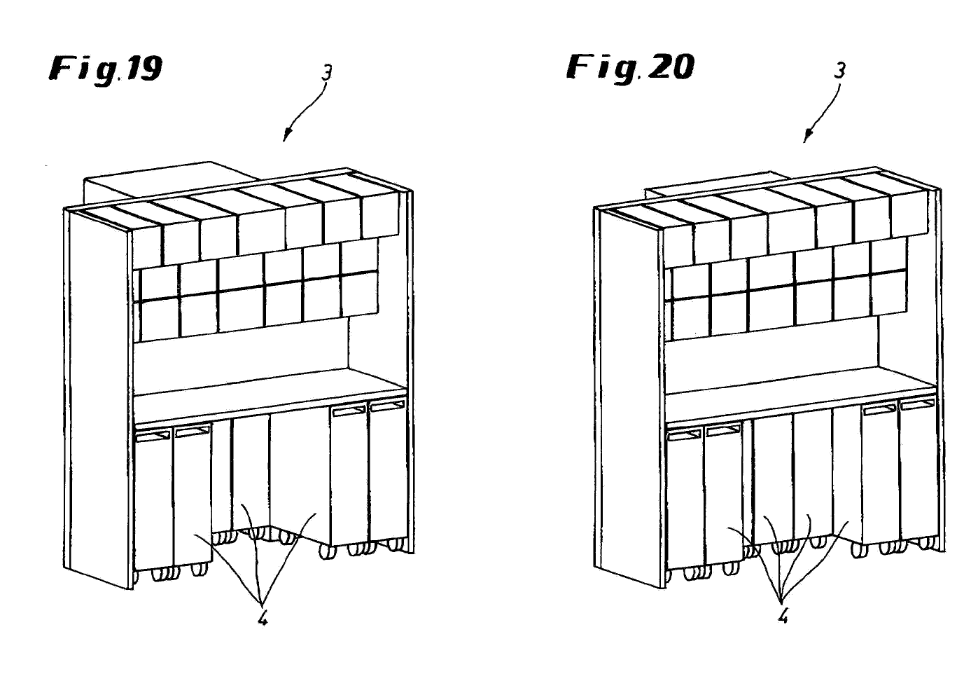

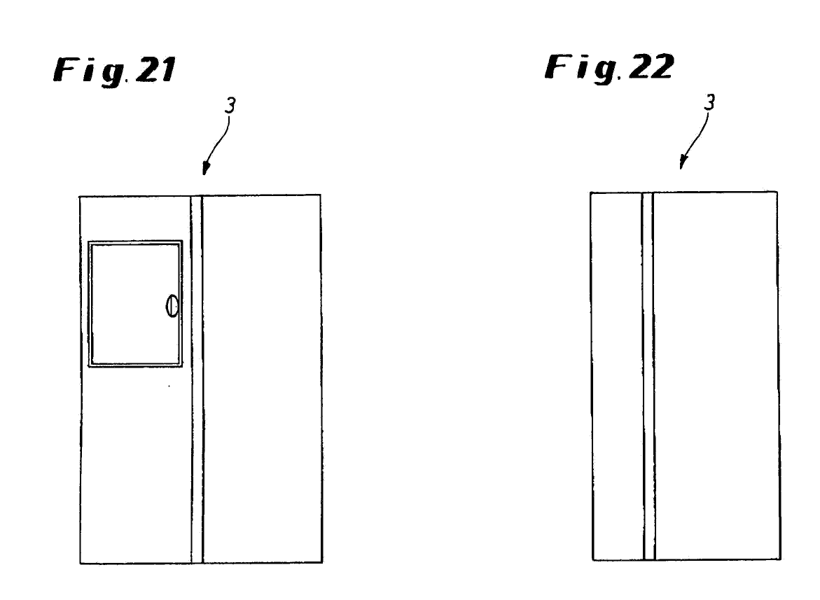

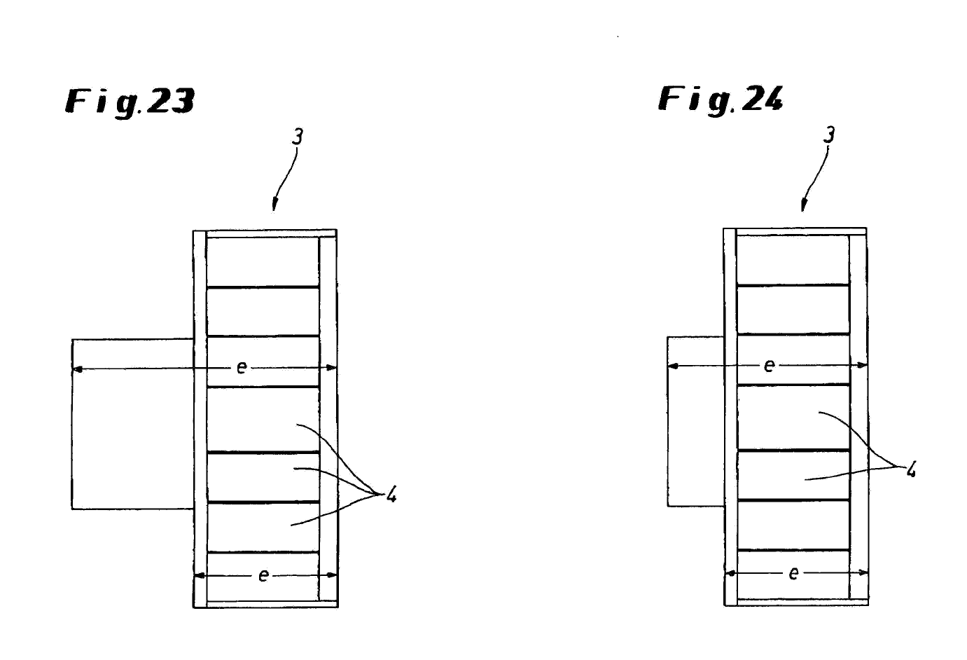

FIG. 18 shows a corresponding galley with a T-shaped configuration with a half depth extension for carts,

FIG. 19 shows a further other galley with a T-shaped configuration with a full depth extension for carts,

FIG. 20 shows a corresponding galley with a T-shaped configuration with depth extension for carts,

FIG. 21 shows a side view of a galley with a T-shaped configuration with a full depth extension for carts,

FIG. 22 shows a corresponding galley with a T-shaped configuration with a half depth extension for carts,

FIG. 23 shows a top plan view of a galley with a T-shaped configuration with a full depth extension for carts and

FIG. 24 shows a corresponding galley with a T-shaped configuration with a half depth extension for carts,

### SPECIFIC DESCRIPTION OF THE INVENTION

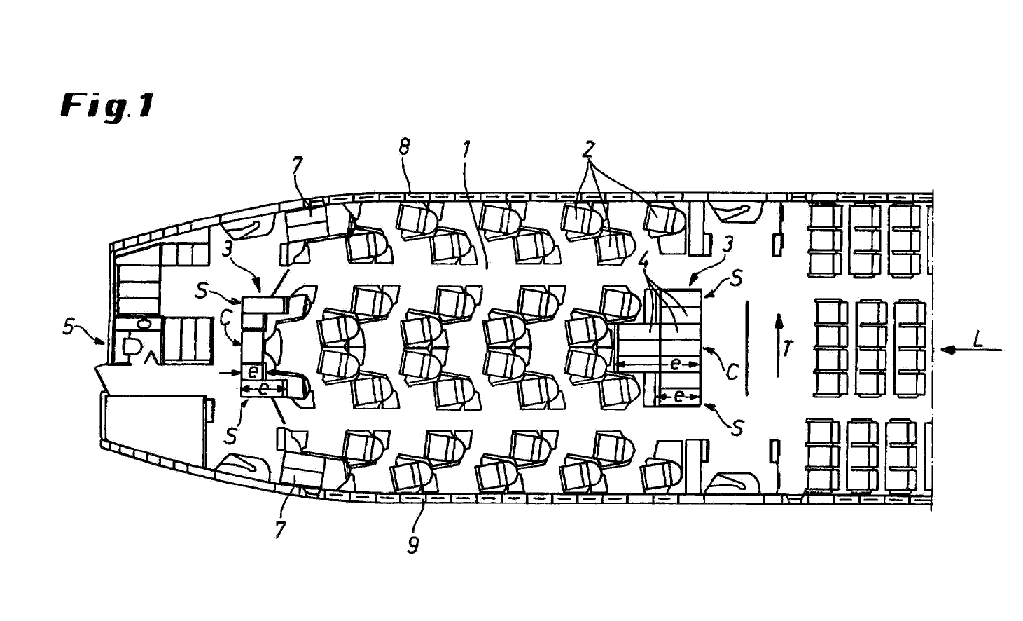

In FIG. 1 a top plan view of an aircraft floor 1 is shown; on the floor 1 a plurality of seats 2 is arranged in known manner. The floor 1 is delimited laterally by side walls 8 and 9. The floor 1 and the aircraft respectively have a longitudinal axis L which extends in the longitudinal direction of the aircraft,

Furthermore, two galleys 3—one in the (left) front region of the floor 1 and one in (right) center region of the floor 1—are arranged in the center area 5 of the floor 1,

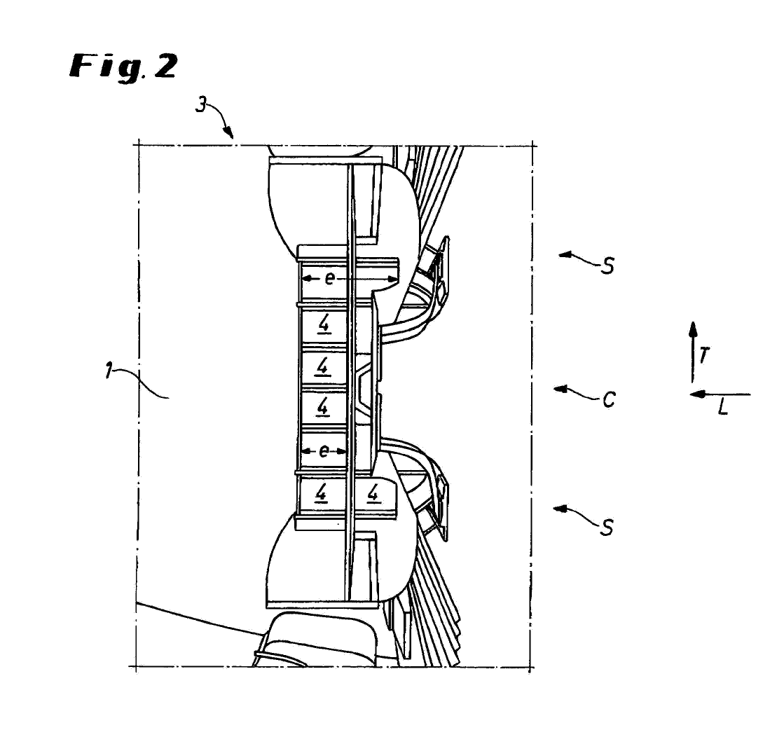

For both galleys 3 it applies that the galley 3 has a receiving space for a plurality of carts and containers 4 respectively, see FIG. 2. The receiving space has an extension e in the direction of the longitudinal axis L. Furthermore, the extension e varies in the direction T horizontally and perpendicular to the longitudinal axis L,

Due to the different extension of the receiving space “half size carts” and “full size carts” can be stowed accordingly

Thereby, the carts can be arranged on the floor, while additional space for stowing is available above the carts,

A design which results from this concept is apparent from FIG. 2. Here is can be seen that the extension e of the receiving spaces for carts 4 is small in the center region C of the galley 3, while it is big in the lateral regions S of the galley 3. Thus, the U-shaped design is given as can be seen in FIG. 2,

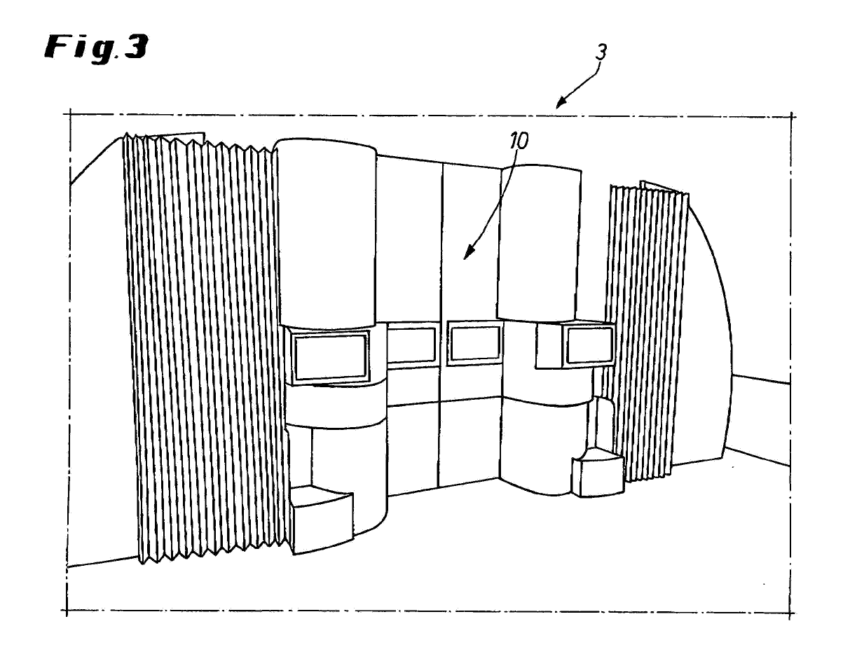

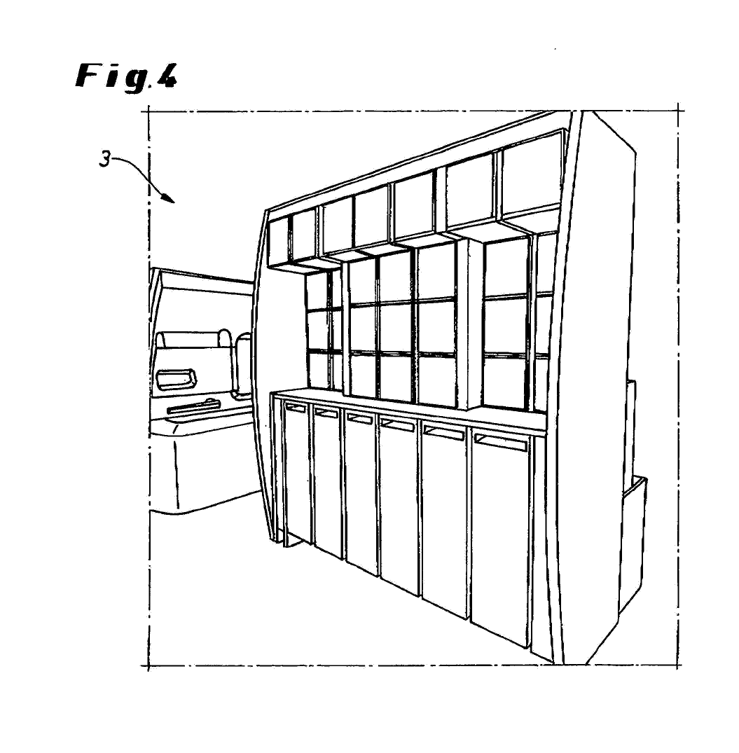

The view which is seen from the seats 2, i.e. from the passengers, is shown in FIG. 3. A seat monument 10 is visible. FIG. 4 shows the galley 3 from the rear side,

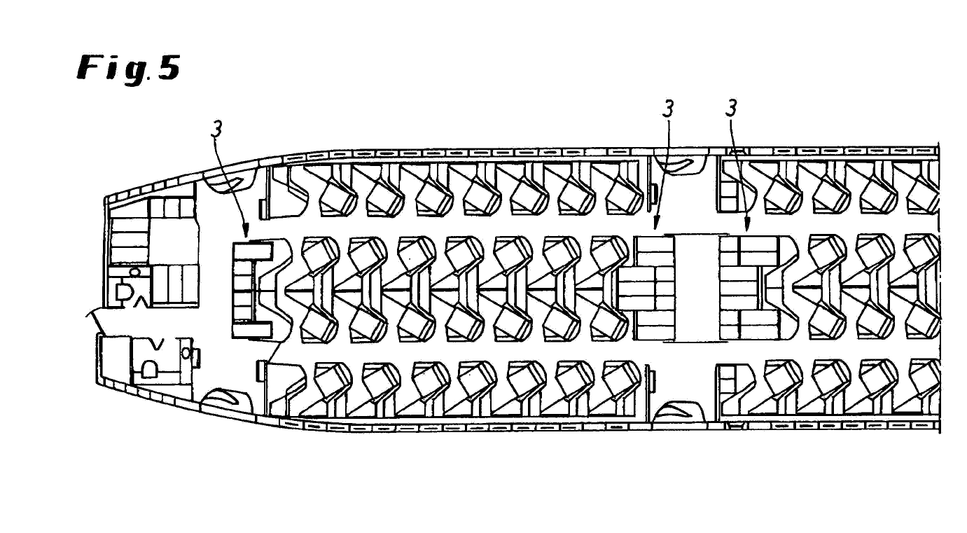

In FIG. 5 a concept is depicted where two galleys 3 are arranged adjacent in the middle region of the floor; a further (left) galley 3 is arranged in the front region of the floor 1. The two adjacent galleys 3 have a specific design, namely a T-shaped top plan view (left one of the two adjacent galleys 3) and a U-shaped top plan view (right one of the two adjacent galleys 3). An aisle between the two galleys 3 remains,

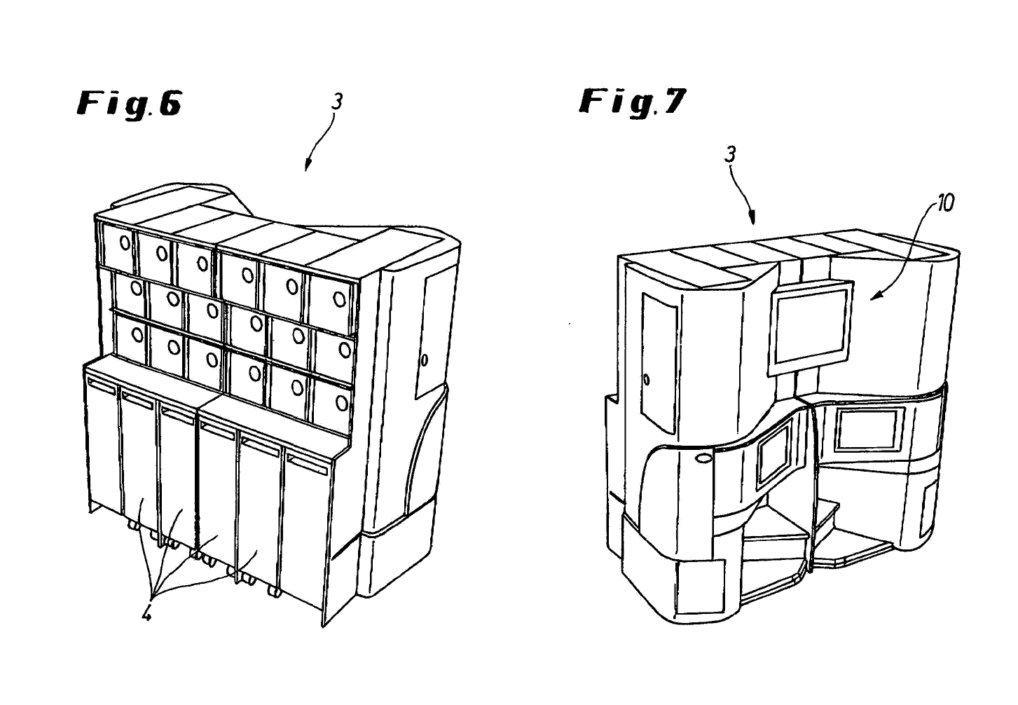

In FIG. 6 and FIG. 7 a U-shaped galley 3 is shown from the rear side (FIG. 6) and from the front side (FIG. 7) as the passengers see it with a seat monument,

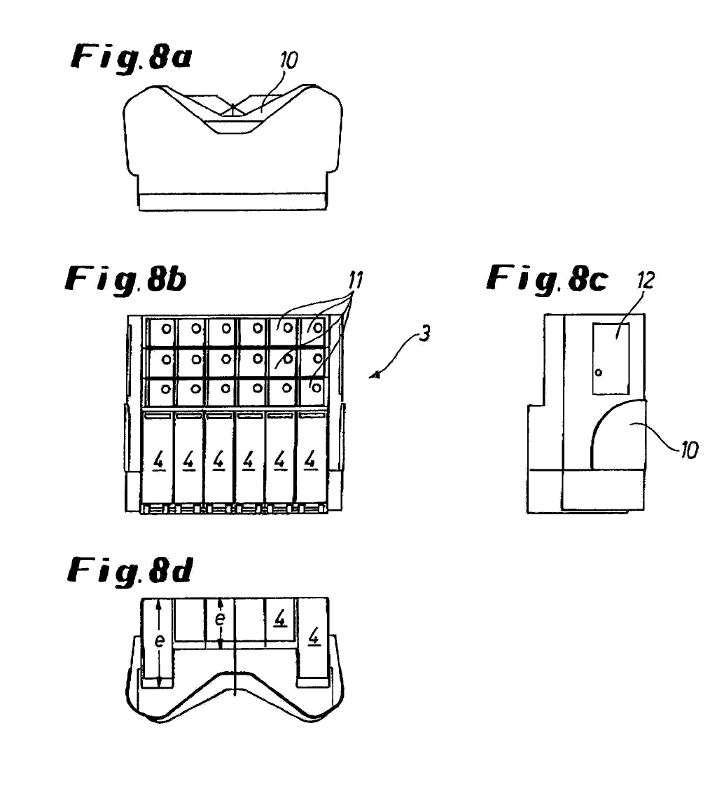

In FIGS. 8a to 8d the galley 3 according to FIGS. 6 and 7 is shown in a top plan view, a front view, a side view and a bottom view. The seat monument 10 is visible, for the passengers. The galley 3 has receiving space for carts 4 as well as for containers 11. Storage space 12 is also available,

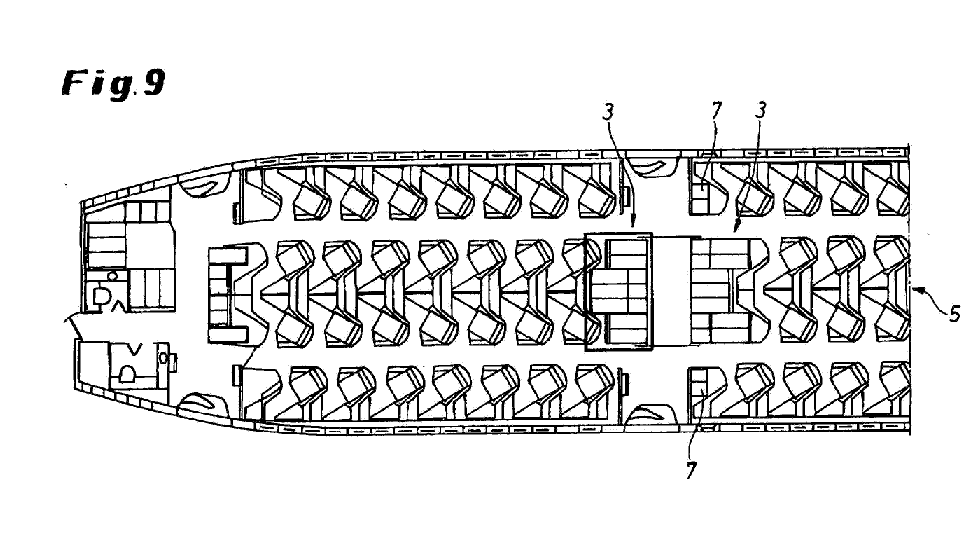

In FIG. 9 it can be seen that also lateral galley sections 7 can be provided beside the galley or galleys in the center area 5 of the floor 1,

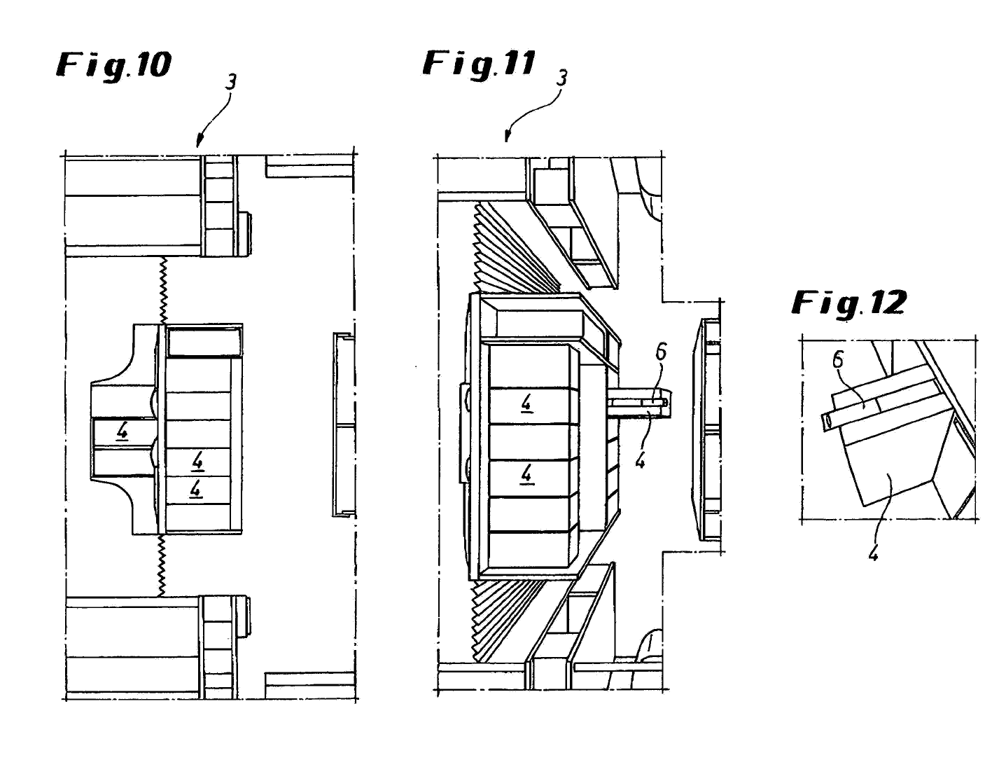

From FIGS. 10 to 12 it becomes apparent that pulling means 6 can be employed to pull out carts 4 from the receiving space in the galley 3. This facilitates to pull out the carts 4 which are arranged in the elongated extension of the receiving space. Also the pulling means can be used for pushing a cart 4 back in the receiving space after use,

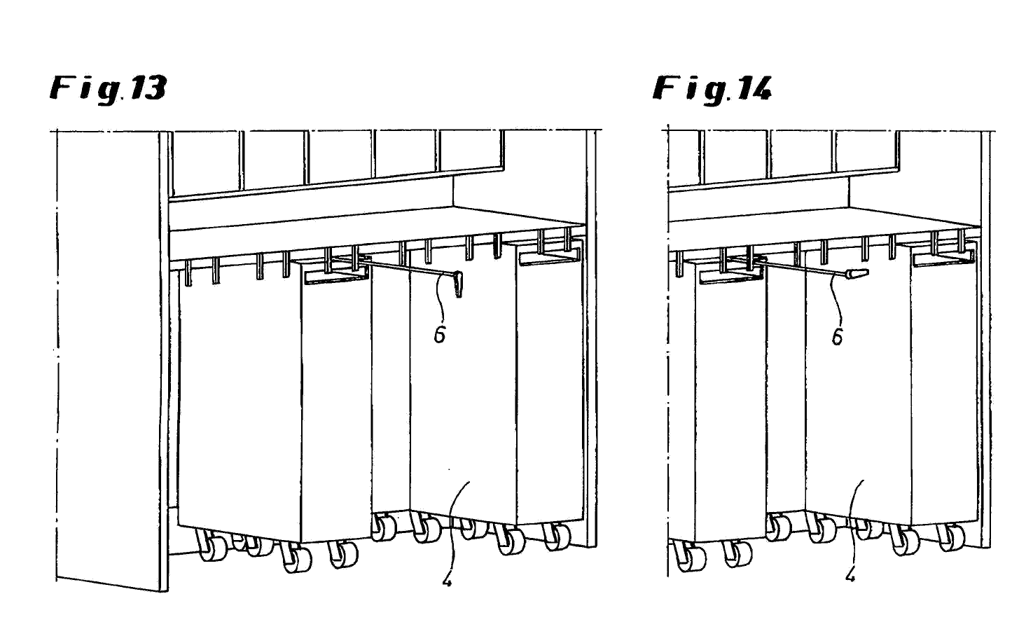

Another design of the pulling means 8 are shown in FIG. 13 and FIG. 14. The pulling means 6 are here rod-shaped. A further feature of the pulling means is that the pulling means 6 according to the embodiment of FIGS. 13 and 14 can be rotated along their longitudinal axis to clamp the cart 4 in the receiving space by twisting. So, the cart 4 can be locked in the position as shown in one of FIGS. 13 and 14 and can be pulled in the position which is shown in the other of the two mentioned figures,

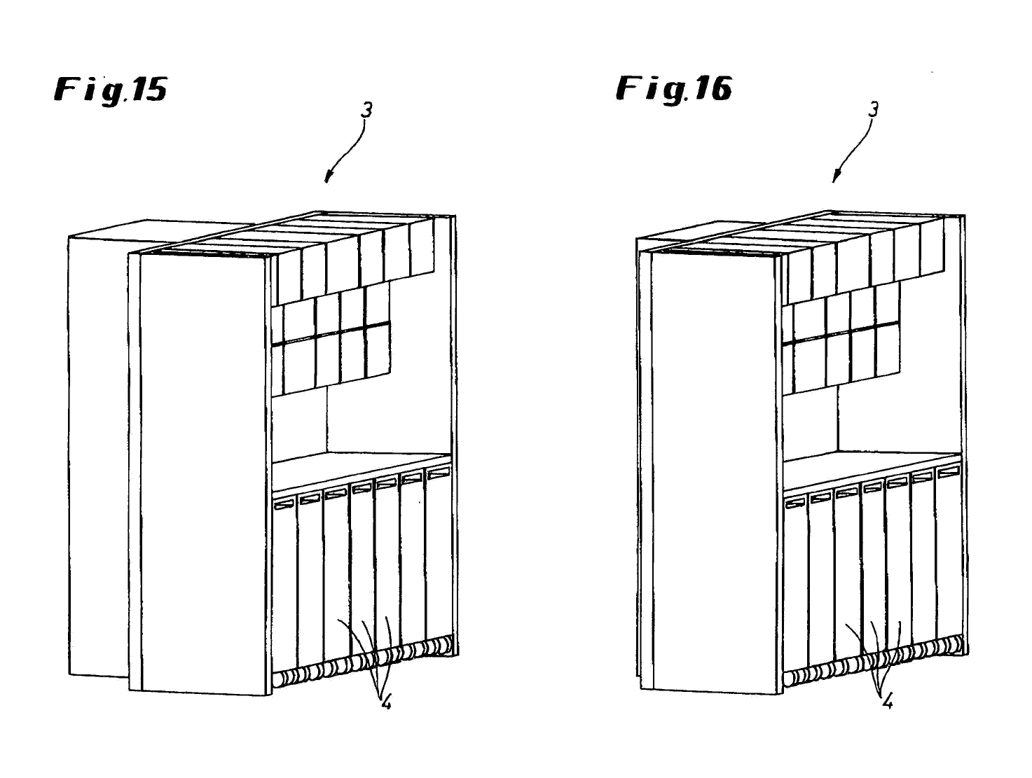

In FIGS. 15 to 24 different other embodiments of the galley according to the invention are depicted,

In FIG. 15 and FIG. 16 a galley 3 is depicted which has a T-shape in a top plan view. In FIG. 15 a “full depth” arrangement is shown, i.e. here in the extended portion of the galley 3 two full shaped carts 4 can be pushed in one after another. In FIG. 16 a “half depth” arrangement is shown; that means that a cart 4 having only 50% of the regular extension can be pushed in the receiving space of the galley 3.

A similar design is shown in FIG. 17 and FIG. 18. FIG. 17 shows the “full depth” arrangement, FIG. 18 the “half depth” arrangement for a T-shaped galley 3.

Again, another- similar design is shown in FIG. 19 and FIG. 20. FIG. 19 shows the “full depth” arrangement, FIG. 20 the “half depth” arrangement for a T-shaped galley 3,

The “full depth” arrangement and the “half depth” arrangement become especially apparent in FIG. 21 and FIG. 22. The “full depth” arrangement according to FIG. 21 has double, the extension of a cart, while the “half depth” arrangement according to FIG. 22 has 1.5-times the extension of a cart.

This arrangement is also apparent in FIG. 23 and FIG. 24. In FIG. 23 the top plan view onto a T-shaped galley 3 is depicted. As can be seen the big extension e is twice of the small extension e. With respect to FIG. 24 it can be seen that the big extension a is about 1.5 times of the small extension e. Thus, in the enlarged part of the galley 3 two carts 4 can be arranged, wherein one cart 4 has a regular extension arid the other cart has an extension of only 50% of it.

The specific design of the galley 3 with its enlarged sections depends on the arrangement of the seats on the floor.

Due to the proposed concept additional stowing space is created for the galley. So, at another location space for arranging additional seats, is developed. The degree of utilization of the aircraft can thus be enhanced, i.e. more passengers can be transported.

1-17. (canceled)

18. An aircraft comprising:
at least one floor having a longitudinal axis extending in a flight direction of the aircraft;
a plurality of seats on the floor;
a galley on the floor;
a plurality of carts or container for food, beverages, or utensils in the galley;
a receiving space in the galley for the carts or containers, extending parallel to the longitudinal axis, and having a horizontal dimension transverse to the longitudinal axis that varies.

19. The aircraft defined in claim 18, wherein the transverse dimension of the receiving space is bigger in a center region of the galley than in an end region of the galley.

20. The aircraft defined in claim 18, wherein the galley is of T-shape seen in top view.

21. The aircraft defined in claim 18, wherein the transverse dimension of the receiving space is bigger in an end region of the galley than in a center region of the galley.

22. The aircraft defined in claim 18, wherein
the galley is of U-shape seen in top view,
the receiving space has one or two small sections with a small constant transverse dimension and one or two big sections with a big constant dimension, and
the transverse dimension in the big section is at least 1.5 times larger than that of the small section.

23. The aircraft defined in claim 22, wherein the transverse dimension of big section is 2.0 times larger than that of small section.

24. The aircraft defined in claim 18, wherein the galley has upper and lower levels for stowing the carts or containers at two different heights.

25. The aircraft defined in claim 18, further comprising:
an elevator for lifting a cart or container to the upper level from the lower level.

26. The aircraft defined in claim 18, further comprising:
pulling means for puling a cart or container out of the receiving space.
